(19) United States
(12) Patent Application Publication
(10) Pub. No.: US 2007/0299754 A1
(43) Pub. Date: Dec. 27, 2007

(54) Fee Generation, Presentation, Billing and Payment Method and Apparatus

(76) Inventor: Jedediah M. Feller, Las Vegas, NV (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/741,573

(22) Filed: Apr. 27, 2007

Related U.S. Application Data
(60) Provisional application No. 60/795,402, filed on Apr. 27, 2006.

(51) Int. Cl. G06Q 20/00; G06F 17/00

(52) U.S. Cl. 705/35; 705/400

(57) ABSTRACT

A fee generation, presentation, billing and payment method and apparatus for service providers is disclosed herein.

### CROSS-REFERENCE TO RELATED APPLICATIONS

This application claims priority of U.S. provisional patent application Ser. No. 60/795,402, filed Apr. 27, 2006.

### FEDERALLY SPONSORED RESEARCH OR DEVELOPMENT

Not Applicable.

### TECHNICAL FIELD

This invention relates to a fee generation, presentation, billing and payment method and apparatus, such as for service providers.

### BACKGROUND OF INVENTION

Service providers, such as lawyers, doctors, dentists, orthodontists, and the like, often provide services of differing complexity, to be performed over differing periods of time, to clients in differing financial conditions. It is often difficult to determine payment options for the client, and to explain the various payment options to the client.

The present invention is provided to address these and other problems.

### DETAILED DESCRIPTION OF THE PREFERRED EMBODIMENT

While this invention is susceptible of embodiments in many different forms, there is shown in the drawings and will herein be described in detail, a preferred embodiment of the invention with the understanding that the present disclosure is to be considered as an exemplification of the principles of the invention and is not intended to limit the broad aspects of the invention to the embodiment illustrated.

The present invention is directed to a fee generation, presentation, billing and payment method and apparatus, such as for professional services provided by professional services providers, such as lawyers, doctors, dentists, orthodontists, financial advisors and the like. The system is software based and may operate on a conventional personal computer having a conventional processor and memory and coupled to a conventional printer. Alternatively the system may be web-based and accessible via the internet, or accessible via other data communication systems.

According to one aspect of the invention, the system provides a set fee discount where a known end value is constrained, and a discount is calculated as a difference between a subtotal and the known end value. Thus, the system establishes a variable discount, displayed as a dollar amount, that is discounted from a previous subtotal to have the resultant subtotal equal the known end value (set fee).

For example, a service provider may have a standard charge to perform a certain service for $5400. The service provider may offer discounts to clients, such as $100 for referring another client, or $50, for arriving at the appointment on-time. Further, the service provider may also have an agreement with a third party, such as an insurance provider, to charge a capped fee of $4200 to certain clients affiliated with the third party, an amount $1200 less than the service provider's standard charge.

Accordingly the system will adjust the amount indicated and displayed as a third party discount, based upon other applicable discounts, in order that the final indicated charge is the capped fee of $4200.

For example, based upon the above numbers, assume a client is to receive both a referral discount of $100 dollars and an on-time discount of $50, for a total discount of $150. The system will calculate a third-party discount of $1050 ($1200-$150). However, if the client is to receive no referral discount and no on-time discount, the system will calculate a third-party discount of the full $1200. In either case, the service provider will receive the full $4200, the maximum permitted by the third party.

Often times payment for services is spread out over time, such as over a period of time for which the services are to be provided. This may result in three variables; down payment, term, and installment payment amount.

The system includes a payment wizard where any of three payment parameters (term, installment payment amount, down payment amount) for a payment schedule are changed and as a result the payment wizard appears and provides the user with four options. An option can be included for selecting a payment schedule where one of the two remaining parameters remains the same as it was before the original parameter was changed and the remaining parameter is calculated accordingly with the original changed parameter and the held constant (chosen to be the same) parameter as set variables in the equation. An option can be included for selecting a payment schedule where the other of the two remaining parameters stays the same as it was before the original parameter was changed and the remaining parameter is calculated accordingly with the original changed parameter and the held constant (chosen to be the same) parameter as set variables in the equation. An option can be included for changing one of the two remaining parameters before calculating the final parameter. An option can be included for changing the other of the two remaining parameters before calculating the final parameter.

This provides a tool to communicate payment options with a client, where one of three parameters is fixed, and the other parameters are allowed to vary.

For example, there may be three payment parameters, term, installment payment (such as monthly) amount and down payment amount. The client may be financially only able to pay a certain down payment amount. Accordingly that down payment amount is entered, and various combinations of term and corresponding installment payment amounts are displayed, permitting the client to select a term and corresponding installment payment amount that best fits the client's needs and abilities. Similarly the client may only be able to afford a certain monthly payment amount. Accordingly that monthly payment amount is entered, and various combinations of term and down payment amounts are displayed, permitting the client to select a term and corresponding down payment amount that best fits the client's needs and abilities.

However, if one of these combinations is not acceptable to the client, a second desired second parameter can be entered and the third parameter will be calculated. For example, if a down payment is entered, various combinations of terms and corresponding installment amounts will be calculated and displayed. If none of these are acceptable to the client, the client can enter a second parameter, such as monthly installment amount, and the term will be calculated.

The payment wizard can include a method where if the term amount is calculated or changed to other than an allowable term as defined by the user in the administrative setup, the term amount is not allowed without authorization, such as in the form of a password, verbal voiceprint, fingerprint or other biometric authorization.

The payment wizard can include a method where if the down payment, or initial payment, is calculated or changed to other than an allowable payment as defined by the user in the administrative setup it is not allowed.

The payment wizard can include a method where if the down payment (initial payment) is calculated or changed to other than an allowable payment as defined by the user in the administrative setup it is not allowed without authorization, such as in the form of a password, verbal voiceprint, fingerprint or other biometric authorization.

Specifically the system will only accept certain payment parameter amounts, such as amounts within a pre-defined range. If a payment parameter amount is entered which is not an acceptable amount, the system will not accept the entered amount. Further, there is a provision to override the prohibition preventing entry of otherwise unacceptable payment parameter amounts, upon entry of proper authorization.

The system provides an exclusionary discount where two or more discounts defined can be selected to be exclusionary to one another. If two or more discounts are selected that are exclusionary to each other and are to be applied to a given account or fee, then one is chosen over the other(s) and applied to the account based on user defined algorithms or programming algorithms.

The system provides an exclusionary discount where two or more discounts defined can be selected to be exclusionary to one another. If two or more discounts are selected that are exclusionary to each other and are to be applied to a given account or fee, then one is chosen over the other(s) and applied to the account based on user defined algorithms or programming algorithms the other(s) can then be displayed with a discount amount less than it's defined amount based on the difference between its defined amount and the amount of a smaller, selected exclusionary discount. In succession, so that all discounts selected are shown with lower amounts than defined but all discounts in sum add up to the largest of the exclusionary discounts selected.

In other words, all potential discounts may be entered, but the system will only apply acceptable ones of the discounts. For example, entry of a discount of 10% may preclude application of a separate $500 discount. Both discounts may be entered, but the system will only apply the 10% discount. The system first applies the largest discount as a first discount, then eliminates all other discounts excluded by this first discount. The system then applies the next largest, still available, discount as a second discount, then eliminates all other remaining discounts excluded by this second discount. This process continues until there are no remaining discounts.

The system provides a split down payment where two or more descriptions can be selected or defined to make up a defined amount of a down payment. For example, a down payment can be split and apportioned to different sub-procedures.

The system provides a defined final payment where one or more descriptions can be given to any given payment where the payment can be taken as part of the term and/or original balance or can be an additional amount added to the original balance and/or term.

The defined final payment provides a method where the final payments can be set at any amount and the remaining payments are calculated accordingly if part of original balance.

For example a final lump sum payment can be scheduled to correspond with the provision by the service provider of a final product upon substantial completion of the services, which can reduce the amount of the monthly payments. For example, an orthodontist may schedule payment of a final lump sum payment upon providing the patient with an orthodontic retainer upon substantial completion of the services.

The system provides a transfer out calculation (project incomplete calculation) where an amount is defined, either as a percentage of the original fee or a dollar amount, that is owed at the initiation of the contract. If the client were then to terminate the relationship the following day, the client would still owe this defined amount, independent of the term of the contract. Another amount is defined that is owed at half completion, and prorated over the length of the first half the project. Another amount is defined that is owed at completion, and prorated over the length of the second half the project. The amount of the first half and the second half may be weighted differently, depending, for example, on the amount of work to be performed during the period.

The transfer out calculation provides a method where an amount is defined that is the minimum amount not owed if project is not completed.

The transfer out calculation provides a method where multiple amounts are defined as minimum amounts not owed if aspects of project are not completed.

Alternatively, the system can define phases of treatment, and a fee amount is applied to each phase of treatment. The transfer out calculation is then based upon how many phases of treatment have been completed.

The system utilizes term of service, credit parameters, and type of service to determine options for payment.

The system provides payment options defined according to type of product or service.

The system utilizes customized fields against term of service to create a table of fees for automated “look up” of fees.

The system utilizes customized fields against customized fields to create a table of fees for automated “look up” of fees.

The system utilizes customized fields against customized fields to create a table of fees along with term of service for automated “look up” of fees.

The system provides a transfer in calculation by defining and automating fees for a project taken over after being started by another service provider according to term of service remaining.

The system defines interest rate in relation to the discrepancy between term of service and term of payments.

For example, the interest rate charged can be increased if the term of payment exceeds the term of service, due to the increased risk to the service provider that payments will not be made upon completion of the services.

The system prints a contract between the client and the service provider, an informed consent document for signature by the client, and a third party contract between the client and a financing company, with one button click.

The system automates generation of a contract between the service provider and the client after a payment option is selected.

In certain situations, the service provider will provide financing for the services provided. In other situations, a third party payment facilitation service, such as a financing service or a factoring service, will be utilized. The payment facilitation service may provide financing. In situations where a third party payment facilitation service provides financing for the services provided, the system sends, upon execution (by clicking execute contract) of a contract, parameters to the third party payment facilitation service for verification and execution by the payment facilitation service, such as by clicking an appropriate screen location to accept.

If the service provider provides the financing, the system transmits, upon execution (by clicking execute contract) of a contract, parameters to a third party automatic withdrawal service for verification and execution. The third party withdrawal service will automatically make monthly withdrawals from an account of the client, such as a checking account.

The service provider may also use a third party payment facilitation service to obtain payment. The payment facilitation service will attempt to collect the monthly payment each month from the client. The payment facilitation service will make payment to the service provider each month, less a discount, regardless of whether the payment facilitation service actually obtains payment from the client. The system executes a contract with the payment facilitation service, which is executed at the click of a button (execute contract).

The system allows the service provider to dictate the terms of the payment contract with the service provider, and the payment facilitation service will guarantee payment when the service provider's account does not exceed a set delinquency rate. This should minimize any tendency for the service provider to only submit high risk clients to the payment facilitation service. Should the delinquency rate exceed the set delinquency rate, the payment facilitation service may renegotiate the discount rate or stop guaranteeing payment with respect to some or all clients.

Where a payment facilitation service provides guaranteed payments up to a certain delinquency rate, the system will warn the service provider that the service provider is approaching a higher than expected delinquency rate.

The system also includes a payment plan wizard where after adjusting one of the three parameters (i.e., term, payment amount, down payment amount) one of the two remaining parameters is recalculated and the other is kept the same by default. This payment plan wizard includes a field for the total charge, as well as for the three parameters.

The payment plan wizard displays these two (one newly calculated and one same) parameters at which point the user can then select to save the new payment plan as newly calculated or allows one or the other of these remaining two parameters to be changed at which point the third parameter is then recalculated.

For example, the system may initially establish that services costing $14,000 will be paid with an initial investment (down payment) of $2000, followed by 24 monthly payments of $500. Should the client desire to only pay an initial payment of $1000, $1000 is entered into the down payment field. By default, the system maintains the term parameter fixed, and recalculates the monthly payment parameter field. The system will not accept a change to the term parameter. Should the client desire to change the recalculated monthly payment, a desired monthly payment is entered into the monthly payment field, and the term is recalculated.

The particular order of default may be set by the user or it may be set by the program.

The system may use more than conventional three factors (e.g., type or class/category/time) to determine a case fee, and the factors can be imported from another system.

For example, in the case of an orthodontist, the orthodontist may utilize such factors when evaluating the patient as treatment type or class (e.g., adult full treatment, etc.), treatment category (e.g., mild, moderate, complex), treatment time (i.e., months of treatment) and overriding categories (e.g., a subjective ranking from A-E).

The system imports these factors from the service providers analysis to determine a case fee and payment options for the client.

Finally, the system produces and delivers a client monthly statement.

The system may be set up such that payments are automatically withdrawn from the client's bank account and/or refunds are automatically deposited to the client's bank account.

From the foregoing, it will be observed that numerous variations and modifications may be effected without departing from the spirit and scope of the invention. It is to be understood that no limitation with respect to the specific apparatus illustrated herein is intended or should be inferred.

What is claimed is:

1. A method of presenting a service provider's fee to a client, wherein the fee has a known end value and is subject to a plurality of possible discounts, the method comprising:
displaying a standard charge;
displaying all applicable discounts;
applying applicable discounts to the standard charge to determine a subtotal amount;
determining a difference between the subtotal amount and the known end-value; and
applying a further discount to the subtotal amount equal to the difference between the subtotal amount and the known end-value.

2. The method of claim 1 wherein certain of the possible discounts are mutually exclusive.

3. The method of claim 2 wherein only one of any mutually exclusive discounts are applied.

4. The method of claim 3 wherein the applied mutually exclusive discount is the greater one of the mutually exclusive discounts.

5. A computer readable memory storing code for performing the following steps to present a service provider's fee to a client, wherein the fee has a known end value and is subject to a plurality of possible discounts, the steps comprising:
displaying a standard charge;
displaying all applicable discounts;
applying applicable discounts to the standard charge to determine a subtotal amount;
determining a difference between the subtotal amount and the known end-value; and
applying a further discount to the subtotal amount equal to the difference between the subtotal amount and the known end-value.

6. The memory of claim 5 wherein certain of the possible discounts are mutually exclusive.

7. The memory of claim 6 wherein only one of any mutually exclusive discounts are applied.

8. The memory of claim 7 wherein the applied mutually exclusive discount is the greater one of the mutually exclusive discounts.

9. A method of determining payment parameters including down payment, term and installment payment amount for a service provider's fee, comprising:
presenting a plurality of payment parameter combinations;
selecting one of the payment parameter options;
changing one of the payment parameters of the selected one of the payment parameter options, wherein one of the other payment parameters is held constant; and
calculating the remaining payment parameter.

10. The method of claim 9 including changing the previously held constant parameter and recalculating the remaining payment parameters.

11. The method of claim 9 wherein the changed one of the payment parameters can only be changed to a value within an acceptable range of values.

12. A computer readable memory storing code for performing the following steps to determine payment parameters including down payment, term and installment payment amount for a service provider's fee, comprising:
presenting a plurality of payment parameter combinations;
selecting one of the payment parameter options;
changing one of the payment parameters of the selected one of the payment parameter options, wherein one of the other payment parameters is held constant; and
calculating the remaining payment parameter.

13. The memory of claim 11 including changing the previously held constant parameter and recalculating the remaining payment parameters.

14. The memory of claim 11 wherein the changed one of the payment parameters can only be changed to a value within an acceptable range of values.
